(19) United States
(12) Patent Application Publication
(10) Pub. No.: US 2006/0172640 A1
(43) Pub. Date: Aug. 3, 2006

(54) Protective pad for clothing

(76) Inventor: Mindy Rose Leake, Soquel, CA (US)

Correspondence Address: MINDY ROSE LEAKE, 233 Spring Street, Santa Cruz, CA, 95060, US

(21) Appl. No.: 10/639,800

(22) Filed: Jan. 28, 2005

(51) Int. Cl. B32B 5/02; B32B 27/04; B32B 27/12

(52) U.S. Cl. 442/59; 442/150; 442/151; 442/149

(57) ABSTRACT

An absorbent patch is shaped and configured to protect a garment from oils and other substances found on the skin of a wearer of the garment. An absorbent pad touches the skin and buffers the garment from the skin while optionally absorbing at least some of the oils and organic material. An adhesive element detachably attaches the patch to the garment. The patch may be shaped to fit with or around particular body areas, such as the underarm, the crotch, the back or an other suitable area.

### FIELD OF THE INVENTION

The present invention relates to fabric as shaped and worn in clothing. The present invention more particularly relates to the protection of fabric from body oils and other substances that comprise organic materials.

### BACKGROUND OF THE INVENTION

The textile industry is one of the largest areas of human economic activity. Textiles as used in clothing are often affected by the body oils and other substances produced by persons wearing the clothing. The useful life of clothing can therefore be limited by damage done to fabric by organic substances introduced by a wearer of the clothing.

There is therefore a long felt need to protect clothing from damage caused in the normal use of the clothing and from organic substances transferred from a wearer to the clothing.

### SUMMARY OF THE INVENTION

It is an objective of the present invention to provide an absorbent patch used to limit the soiling of a garment. These and other objects will be apparent in light of the prior art and this disclosure.

Certain preferred alternate embodiments of the present invention comprise an absorbent pad that is attachable by an adhesive side to clothing articles worn by an individual and that conforms to the movement of the clothing articles to provide for decreased soiling of the garment.

In a first preferred embodiment, an absorbent patch of the present invention includes an absorbent and adhesive patch that is irremovably mountable to the inside underarm area of a garment.

The absorbent and adhesive patch may optionally include an adhesive substance impressed, formed or coated on the pad's rear surface. This adhesive may be a low-application temperature adhesive, or a hot-melt. A peel away paper strip may cover the adhesive substance, and can be quickly removed for exposing the adhesive substance and pressing the adhesive substance against the clothing article for attaching the patch to the clothing article. This peel away paper strip may be made form a substance such as wax paper, or another suitable substance known in the art. The patch may also comprise an absorbent side to intake excess sweat from the under arms and therefore reduce soiling of the clothing article. This patch is preferably made from a pliable fabric or cloth material that allows the patch to bend, flex, and conform to some degree to the movements of the clothing article. This pliable fabric or cloth material may comprise wood cellulose fiber, cotton, polyester, or synthetic rayon, or any suitable fabric known in the art. Covering the absorbent side of the patch may be a moisture protective shield made with moisture proof plastic polypropylene or polyethylene.

It is an objective of the present invention to provide an absorbent patch that is easily and quickly mountable to and removable from any type of clothing article such as a shirt or a dress.

It is another objective of the present invention to provide an absorbent patch that will absorb sweat from under the arms and reduce soiling of a clothing article.

Other aspects of the present invention include an apparatus and a computer-readable medium configured to carry out the foregoing steps. The foregoing and other objects, features and advantages will be apparent from the following description of the preferred embodiment of the invention as illustrated in the accompanying drawings.

### BRIEF DESCRIPTION OF TIE DRAWINGS

These, and further features of the invention, may be better understood with reference to the accompanying specification and drawings depicting the preferred embodiment, in which: These, and further features of the invention, may be better understood with reference to the accompanying specification and drawings depicting the preferred embodiment, in which:

FIG. 1: Take two pieces of absorbent fabric. Separately fold each piece of fabric in half, now fold in half again. #1-12

FIG. 2: Mark the fabric so that there are four 3.5 inch lines making a square. Cut along these lines for both squares. There will now be layers of squares stacked together. #13-21.

FIG. 3: Fold a piece of tape over each side of the square so that the pieces are held together, #22-41.

FIG. 4: Place four pieces of double sided tape 3.5 inches long along the outside edges of one side of each square. Then place two shorter pieces of double sided tape in the center of the square. This will make one side of each square sticky, #42-64.

FIG. 5: Cut out two squares of wax paper 3.5 inches by 3.5 inches to make two squares. Place the wax paper squares on the sticky sides of the patches, to be removed at time of use. #'s 43, 45, 66, 65, and 68.

FIG. 6: This will provide two complete two sided pit-stopper with a protective flap. #69-88.

FIG. 7: Turn the squares so they look like diamonds. Place the squares, sticky side down onto the inside arm-pit of a clothing article. The diamond should be placed for maximum protection and comfort, with one point of the diamond centered in the sleeve and the other point centered towards the chest, #90-104.

### DESCRIPTION OF THE PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

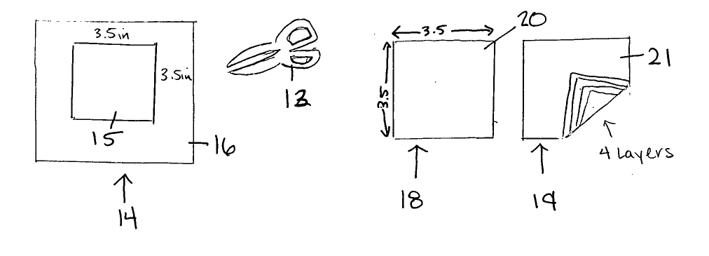

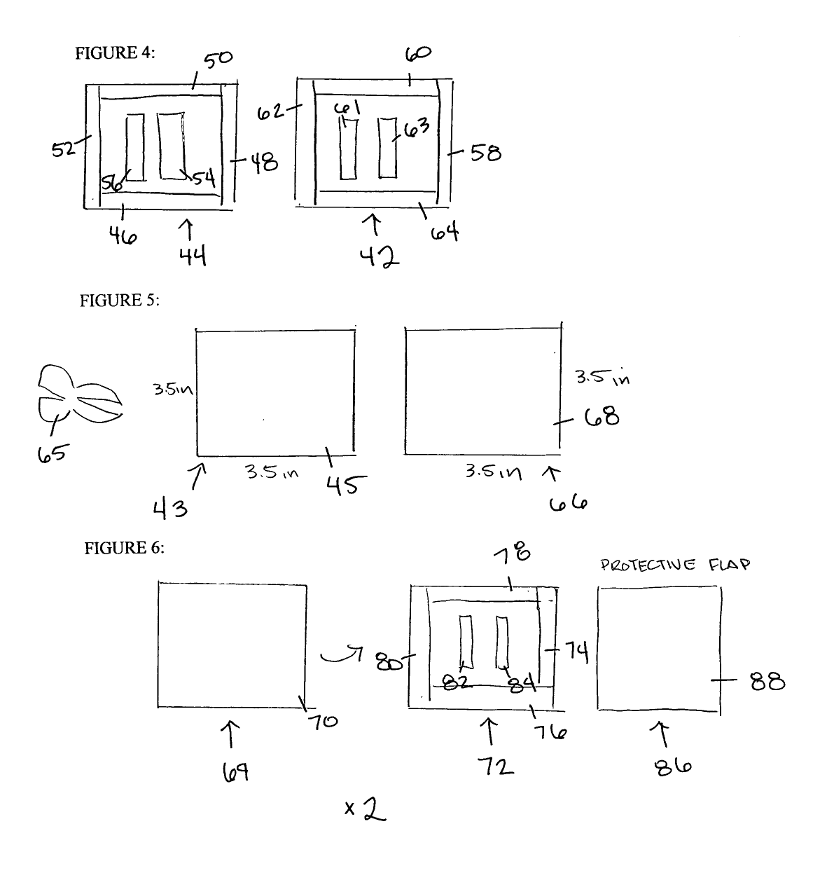

Illustrated in FIGS. 1-7 is an absorbent, adhesive patch that is removable attachable to the underarms of an article of clothing in order to absorb sweat from under the arms and reduce soiling of the garment. The absorbent patch can be worn by any individual and can be used at any time of the day or night. The patch will absorb sweat from the underarms of these individuals to reduce noticeable soiling of the clothing article the set patch is attached to.

As shown in FIGS. 1-7 the absorbent patch of the present invention comprises a square of diamond shape. While the absorbent patch can be of almost any geometric configuration, a shape that will cover the maximum possible area and fit well under the arms is preferred. The patch should be pliable in order to flex, bend an conform to the shape and movement of the clothing article worn by the individual, it should also have a high absorbency, and is therefore preferably manufactured from wood cellulose fibers, cotton, polyester, or synthetic rayon.

As shown in FIGS. 1-7 the absorbing patch of the present invention comprises a diamond shaped absorbent pad that is removable attachable to an area or portion of an article of clothing. Which should be attachable by an adhesive such as a hot-melt or a low application hot-melt.

As shown in FIGS. 1-7 the absorbent patch of the present invention comprises an adhesive side to be covered by a nonstick removable flap. This flap is to be removed at the time of use and is to be comprised of a substance such as wax paper.

As shown in FIGS. 1-7 the absorbent patch of the present invention comprises a front surface made form and absorbent material which is to be covered by a moisture protective shield. This moisture protective shield is to be comprised of moisture proof plastic polypropylene or polyethylene.

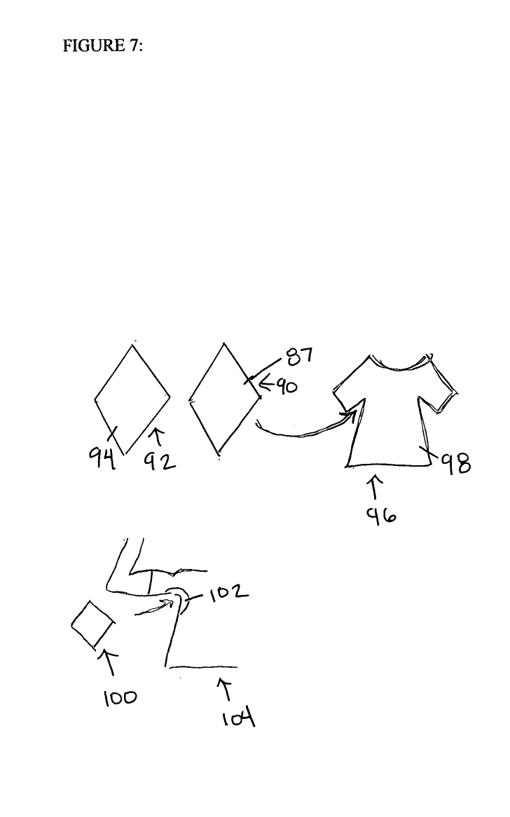

As shown in FIGS. 1-104 the moisture absorbent patch is defined by an absorbent front surface 69, an opposite rear surface 72, and a nonstick flap 86. The preferred manner of mounting the patch 69, to the clothing article is by manually adhering the patch 69, to the clothing article. Thus as shown in FIG. 7, the rear surface 72, of the patch is treated or coated with an adhesive substance. The adhesive substance is fully covered and protected by a strip of paper 86, having the same dimensions as the rear surface 72, of the patch 69. The paper strip 86, can be easily and quickly peeled away to expose the adhesive substance where upon the individual would firmly press the rear surface 72 of the patch 69, against the clothing article to mount the patch 69 to the clothing article. The absorbent patch 69 will have a minimum and maximum size for the greatest use and coverage. These sizes will be constrained by the respective activity for which the patch 69 will be adhered.

Those skilled in the art will appreciate that various adaptations and modifications of the just-described preferred embodiments can be configured without departing from the scope and spirit of the invention. Other suitable fabrication, manufacturing and assembly techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

I claim:

1. An absorbent patch to secure to the inside underarms of a shirt that will absorb excess sweat to prevent sweat marks on the shirt, the patch comprising: an absorbent front surface and an adhesive rear surface.

2. The absorbent patch of claim 1 wherein the rear surface of the patch includes an adhesive substance that can be pressed against the inside under arms of a shirt for securing the patch to the shirt.

3. The absorbent patch of claim 2 wherein the adhesive substance used on the rear side is a low-application-temperature adhesive or a hot-melt.

4. The absorbent patch of claim 2 further comprising a paper strip positioned adjacent to the rear surface of the frame for covering and protecting the adhesive substance on the patch and which is peel able from the adhesive substance.

5. The absorbent patch of claim 4 wherein the nonstick flap to the adhesive side is wax paper.

6. The absorbent patch of claim 1 wherein the front surface of the patch comprises an absorbent side to absorb sweat from the underarms.

7. The absorbent patch of claim 6 wherein the front absorbent side consists of wood cellulose fibers, cotton, polyester, or synthetic rayon.

8. The absorbent patch of claim 1 wherein there is a moisture protective shield made with moisture proof plastic polypropylene or polyethylene.
